(19) United States
(12) Patent Application Publication
(10) Pub. No.: US 2015/0221025 A1
(43) Pub. Date: Aug. 6, 2015

(54) METHOD, SYSTEM, AND COMPUTER PROGRAM PRODUCT FOR DETERMINING A PAYMENT STRATEGY

(71) Applicant: Amadeus S.A.S., Sophia Antipolis (FR)

(72) Inventors: Laure Canis, Nice (FR); Mathieu Le Marier, Antibes (FR); Nicolas Hirel, Biot (FR); Thibaud Andrevon, Vallauris (FR)

(73) Assignee: Amadeus S.A.S., Sophia Antipolis (FR)

(21) Appl. No.: 14/171,061

(22) Filed: Feb. 3, 2014

(51) Int. Cl. G06Q 40/00; G06Q 10/06

(52) U.S. Cl. CPC G06Q 40/00; G06Q 10/067

(57) ABSTRACT

Methods, systems, and computer program products for handling a payment strategy for a payment platform of an airline merchant. One or more alternatives are determined for each category. Each alternative includes at least one of the one or more payment items. Transactions are received for different combinations of the alternatives. Financial impacts are determined for each simulated transaction based on the financial parameters. Based on the financial impacts, one of the combinations of the alternatives is determined to be the payment strategy for the payment platform.

### BACKGROUND

The invention generally relates to computers and computer software and, in particular to methods, systems, and computer program products for determining a payment strategy in a merchant environment.

Airline merchants have a need to integrate different and complex types of solutions to validate customer payments, combat fraud, and enable fund collection while operating within regulations and standards across a complex and fragmented payment industry. Payment platforms may offer solutions for payment processing that can help improve conversion rates, ensure revenue protection, and reduce costs. Payment platforms may provide travel agencies and travel industry companies with the computing environment for processing all of the payment services for the airlines. The payment services generally cover payment fraud screening to detect risks of fraud associated to a payment request, payment authorization to evaluate whether sufficient funds are available for payment and to block funds when necessary, etc.

Airline merchants must select payment parameters, such as the methods of payment to accept, the payment processors and the payment acquirers to use, and the fraud management schemes or strategies to adopt. Decisions about these payment parameters may be based upon experience and/or based upon on commercial relationships, rather than a robust evaluation of the financial impact of each payment parameter representing a potential alternative choice. As a result, an airline merchant may select payment parameters that do not necessarily match its overall operating mode.

There is a need for methods, systems, and computer program products to determine a payment strategy in a merchant environment, such as an airline merchant environment.

### SUMMARY

Embodiments of the present invention are directed to systems, methods, and computer program products to determine a payment strategy in a merchant environment, such as an airline merchant environment. Consistent with embodiments of the invention, financial parameters, categories, and one or more payment items for each category are received. One or more alternatives are determined for each category. Each alternative includes at least one of the one or more payment items. Transactions are received for different combinations of the alternatives. Financial impacts are determined for each simulated transaction based on the financial parameters. Based on the financial impacts, one of the combinations of the alternatives is determined to be the payment strategy for the payment platform.

### BRIEF DESCRIPTION OF THE SEVERAL VIEWS OF THE DRAWINGS

The accompanying drawings, which are incorporated in and constitute a part of this specification, illustrate various embodiments of the invention and, together with a general description of the invention given above and the detailed description of the embodiments given below, serve to explain the embodiments of the invention.

FIG. 1 is a diagrammatic view of an exemplary operating environment including a plurality of computer systems.

FIG. 2 is a diagrammatic view of an exemplary computer system for determining a payment strategy in accordance with an embodiment of the invention.

FIG. 3 is a flow diagram illustrating a general process flow for determining a payment strategy in accordance with an embodiment of the invention.

FIG. 4 is a flow chart of a process flow for determining payment categories and payment alternatives in accordance with an embodiment of the invention.

FIG. 5 is a flow chart of a process flow for simulating transactions in accordance with an embodiment of the invention.

FIG. 6 is a flow chart of a process flow for determining payment items of each payment category in accordance with an embodiment of the invention.

FIG. 7 is a flow chart of a process flow for acquiring financial inputs in accordance with an embodiment of the invention.

FIG. 8 is a flow chart of a process flow for determining the NPV in accordance with an embodiment of the invention.

FIG. 9 is a flow chart of a process for determining an optimized NPV after the NPVs have been computed in FIG. 8.

### DETAILED DESCRIPTION

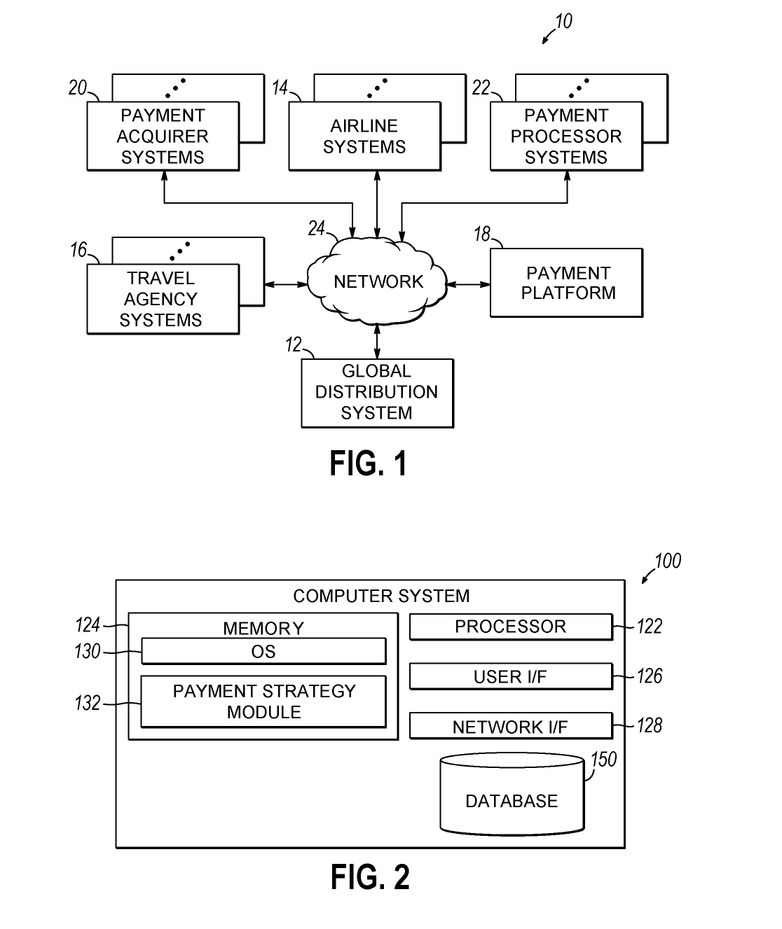

Referring now to FIG. 1, an operating environment 10 for an airline merchant may include a Global Distribution System (GDS) 12, one or more travel product provider systems, such as airline systems 14, one or more indirect seller systems, such as travel agency systems 16, a payment platform 18, one or more payment acquirer systems 20, and one or more payment processor systems 22. The GDS 12, airline systems 14, travel agency systems 16, payment platform 18, payment acquirer systems (e.g., financial institutions such as banks) 20, and payment processor systems 22 may be coupled to a communication network 24. The network 24 may include one or more private and/or public networks (e.g., the Internet) that enable the exchange of data. The airline systems 14 may each include a reservation system that enable airline ticketing offices, the GDS 12, and/or the travel agency systems 16 to find, book, and pay for airline tickets. In one embodiment, the payment system 20 may be hosted at an airline IT solution provider and may offer the management of payment transactions for sales performed across all channels on behalf of an airline operating as a merchant.

FIG. 2 provides a block diagram that illustrates the components of the one or more servers of a computer system 100 configured to determine a payment strategy in accordance with an embodiment of the invention. The computer system 100 may comprise an element of the GDS 12, an element of an airline IT solution provider, and/or may be an element of the payment platform 18. The computer system 100 includes at least one processor 122 including at least one hardware-based microprocessor and a memory 124 coupled to the at least one processor 122. The memory 124 may represent the random access memory (RAM) comprising the main storage of the computer system 100, as well as any supplemental levels of memory, e.g., cache memories, non-volatile or backup memories (e.g., programmable or flash memories), read-only memories, etc. In addition, memory 124 may be considered to include memory storage physically located elsewhere in the computer system 100, e.g., any cache memory in a microprocessor, as well as any storage capacity used as a virtual memory, e.g., as stored on a mass storage device or on another computer coupled to the computer system 100.

For interface with a user or operator, the computer system 100 may include a user interface 126 incorporating one or more user input/output devices, e.g., a keyboard, a pointing device, a display, a printer, etc. Otherwise, data may be communicated to and from another computer or terminal (e.g., the airline systems 14, the payment platform 18) over a network interface 128 coupled to the communication network 24. The computer system 100 also may be in communication with one or more mass storage devices, which may be, for example, internal hard disk storage devices, external hard disk storage devices, external databases, storage area network devices, etc.

The computer system 100 typically operates under the control of an operating system 130 and executes or otherwise relies upon various computer software applications, components, programs, objects, modules, engines, data structures, etc., including for example, a payment strategy module 132. In general, the computer system 100 may be configured to interface with one or more users, such as an airline merchant, in association with payment services and, in particular, in association with the determination of a payment strategy.

The memory 124 of the computer system 100 may generally store one or more databases including, for example, a database 150. The database 150 may comprise data and supporting data structures that store and organize the data. In particular, the database 150 may be arranged with any database organization and/or structure including, but not limited to, a relational database, a hierarchical database, a network database, and/or combinations thereof. A database management system in the form of a computer software application executing as instructions on the processing unit of the computer system 100 may be used to access the information or data stored in records of the database 150 in response to a query.

Moreover, various applications, components, programs, objects, modules, engines etc. may also execute on one or more processors in another computer coupled to the computer system 100 via the communication network 24, e.g., in a distributed or client-server computing environment, whereby the processing required to implement the functions of a computer program may be allocated to multiple computers over a network. For example, some of the functionality described herein as being incorporated into the computer system 100 and/or modules of the computer system 100 may be implemented in one or more servers. Consistent with embodiments of the invention, the module 132 and/or other such modules, applications, and/or engines may be executing on one or more servers of the computer system 100, and the modules 132 may cause the processor 122 of the computer system 100 to perform operations consistent with embodiments of the invention.

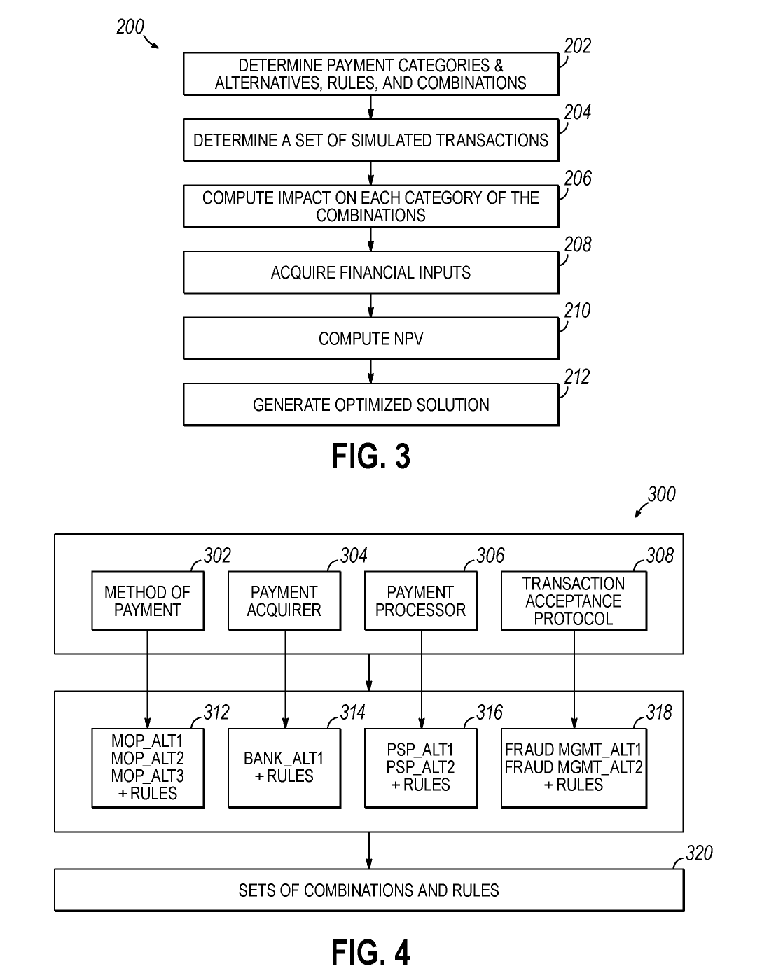

With reference to FIG. 3 and in accordance with an embodiment of the invention, a general process flow chart 200 to determine a payment strategy using the computing device 100 is shown. Each block of the general process flow chart 200 is further detailed with reference to FIGS. 4 to 8.

A user is prompted to specify payment parameters in the form of payment categories 302. For each payment category, the user is further prompted to provide payment alternatives in the form of payment items that represent selection alternatives. A set of payment rules may be specified by the user for each payment item in a payment category. The payment categories, payment items in each payment category, and/or the payment rules for each payment item may be communicated over the network 20 from one of the airline systems 14 to the computer system 100, which receives this information as data to apply in the determination of the payment strategy.

A set of payment combinations is determined by the computer system 100 that groups the payment categories and the payment items selected as alternatives for each payment category with associated payment rules (block 202). A set of transactions is simulated by the computer system 100 for a specific payment category (block 204). For each payment combination generated in block 202, the impact on each payment category of the payment combination is computed by the computer system 100 for each simulated transaction (block 206). In block 208, financial parameters are acquired by the computer system 100. In block 210, the computer system 100 uses the financial parameters to compute the net profit value (NPV) for each payment combination. In block 212, the NPV for the different payment combinations are compared by the computer system 100 to provide a total financial impact of each payment strategy alternative, thereby allowing providing a payment strategy recommendation to the user.

With reference to FIG. 4, a flow diagram of the process for populating the payment categories with payment alternatives is described. Multiple payment categories 300 may be defined that may include, but are not limited to, a payment category 302 for method of payment (MOP), a payment category 304 for payment acquirer (e.g., bank), a payment category 305 for payment processor (PSP), and a payment category 308 for transaction acceptance protocol. Each of the payment categories 302, 304, 306, 308 may comprise multiple payment items. For example, the payment items of the payment category 302 for MOP may comprise credit cards, such as credit cards branded by different financial services corporations (e.g., Visa®, MasterCard®, or American Express®), and on-line payments through the Internet (e.g., PayPal®). As another example, the payment category 308 for transaction acceptance protocol may include payment items such as accept or reject decisions, or obtaining further information before making a final acceptance decision (e.g., manual review, 3D Secure®, or SecureCode® authentication).

The determination of payment strategy may be performed and accessed through a user interface either directly on the computer system 100 or from a remote server over the World Wide Web on the Internet via a Uniform Resource Locator (URL). The user interface may be configured similar to user interface 126 such that a user can enter the payment categories, select different payment categories from a proposed list of options, or chose the payment categories from a mixture of selections and voluntary inputs.

The payment items that are alternatives for each of the payment categories 302, 304, 306, 308 may be created and registered using an alternative registration component and, in each instance, payment items that represent alternatives for each specific payment category may be created by a sub-component of the registration component. The user may enter or select payment items from a plurality of available payment items in order to identify alternatives for each of the payment categories 302, 304, 306, 308 to the computer system 100. If the user is already operating with the computer system 100, any payment items already received and used by the payment platform may be tagged or labeled as ‘current context’ or ‘historical’, which is received at the computer system 100. The user interface may be configured to offer the user a specific delimited area to enter the historical items for each payment category and another specific delimited area to enter the other payment items. The user may optionally provide specific rules to the computer system 100 that may be applied to the payment items of one or more of the alternatives in each of the payment categories 302, 304, 306, 308. In an alternative embodiment, the specific rules may also be retrieved by the computer system 100 from a database that stores predefined rules and/or historical rules (e.g., database 150).

For example and as illustrated with a representative use case, the user may select from among the available MOPs to define various different payment alternatives 312 for category 302. The user may select a payment alternative 312 (i.e., MOP_Alt1) that includes a group of payment items (Visa, MasterCard). MasterCard, for example, may be tagged as in the payment alternative (MOP_Alt1) 312 as ‘historical’, which indicates that this particular MOP is already used by the user. The user may select another payment alternative 312 (i.e., MOP_Alt2) that includes a group of payment items (Visa, MasterCard, Amex). The user may select yet another payment alternative (MOP_Alt3) 312 that includes a group of payment items (Visa, MasterCard, Amex, PayPal).

One or more rules governing the methods of payment may be applied to restrict the ability to initiate on-line payments with one of the payment items according to, for example, country or geographic territory. As a specific example, a rule may specify that one of the payment items may be restricted to use only for transactions initiated in the United States. It is appreciated that any variant in the rules formulation may be devised from the context of the airline merchant.

The computer system 100 may apply the rules to determine the payment alternatives 312 for the payment strategy. As a specific example based on PayPal being restricted to only for transactions initiated in the United States, the MOP rules may be: A) if the country is ‘US’, then the set of MOPs available for selection is Visa, MasterCard, Amex, and PayPal; and B) for any country other than the ‘US’, then the set of MOPs available for selection is equal to Visa, MasterCard, and Amex. In particular, these MOP rules may be applied to the third alternative (MOP_Alt3) of category 302 discussed in the representative use case.

For the payment category 304, the user may select one or more alternatives 314 for the payment acquirer. In the representative embodiment, a single alternative (Bank_Alt1) 314 is created and registered for the payment acquirer that selects one financial institution or bank to handle all transactions. For purposes of the example and representative use case, the alternative (Bank_Alt1) 314 may comprise the historical payment acquirer for the airline merchant. One or more rules may be applied to account for limitations, such as geographical limitations, on the availability of different payment acquirers.

For the payment category 306, the user may select one or more alternatives 316 for the payment processor. In the example and representative use case, the user may create and register an alternative (PSP_Alt1) 316 to select a payment processor that is operatively in communication with the payment acquirer of the selected alternative (Bank_Alt1) 314. For purposes of illustration, the payment processor of the selected alternative (PSP_Alt1) 316 may be a historical payment processor for the airline merchant. The user may create and register another alternative (PSP_Alt2) 316 that includes a different payment processor that is not necessarily operatively in communication with the payment acquirer of the alternative (Bank_Alt1) 316. However, the user may want the different alternative (PSP_Alt2) 316 to be studied by the process determining the payment strategy. One or more rules may be applied to account for limitations, such as geographical limitations, on the availability of different payment processors.

The computer system 100 may be configured to validate that the particular payment processors entered by a user are valid payment processors to handle all the MOPs previously selected by the user, and to inform the user of any incompatibilities.

For the payment category 308 for transaction acceptance protocol, the user may select one or more alternatives 318 for transaction acceptance protocol. In the example and representative use case, the user may create and register an alternative (Fraud Mgt_Alt1) 318 for transaction acceptance protocol based on a fraud screening provider having rules based on transaction data leading to accept, manually review, or reject decisions. For purposes of illustration, the alternative (Fraud Mgt_Alt1) 318 for transaction acceptance protocol may include the historical transaction acceptance protocol used by the airline merchant. Another alternative (Fraud Mgt_Alt2) 318 for transaction acceptance protocol may be created (e.g., a transaction acceptance protocol based on the use of a 3D Secure authentication). The alternative (Fraud Mgt_Alt2) 318 for transaction acceptance protocol may be independent-channel secure authentication validation mode. One or more rules may be applied to account for limitations, such as geographical limitations, on the availability of different transaction acceptance protocols.

After all payment alternatives are created for the payment categories 302, 304, 306, 308, combinations 320 of the payment alternatives 312, 314, 316, 318 for the payment categories 302, 304, 306, 308 and rules are generated or determined by the computer system 100 to establish different sets of combinations and rules.

For example, the following representative combinations may be generated for the payment alternatives 312, 314, 316, 318 of the representative use case in FIG. 3. Combination 1 may include MOP_Alt1 as the alternative 312 for method of payment, Bank_Alt1 as the alternative 314 for payment acquirer, PSP_Alt1 as the alternative 316 for payment provider, and Fraud Mgt_Alt1 as the alternative 318 for transaction acceptance protocol. Combination 2 may include MOP_Alt2 as the alternative 312 for method of payment, Bank_Alt1 as the alternative 314 for payment acquirer, PSP_Alt1 as the alternative 316 for payment provider, and Fraud Mgt_Alt1 as the alternative 318 for transaction acceptance protocol. Combination 3 may include MOP_Alt3 as the alternative 312 for method of payment, Bank_Alt1 as the alternative 314 for payment acquirer, PSP_Alt2 as the alternative 316 for payment provider, and Fraud Mgt_Alt2 as the alternative 318 for transaction acceptance protocol. Combination 1 may represent a historical combination of payment alternatives, i.e., the one combination of payment alternatives currently used by the airline merchant. Each combination of alternatives is moreover associated with rules that may be defined for each payment category. It is to be appreciated that other combinations may be generated, such as, for example, a Combination 4 based upon combination 2, but having rules defining that if the country is the United States, then MOP_Alt2 is applied as the alternative 312 for method of payment; otherwise, MOP_Alt1 is applied as the alternative 312 for method of payment.

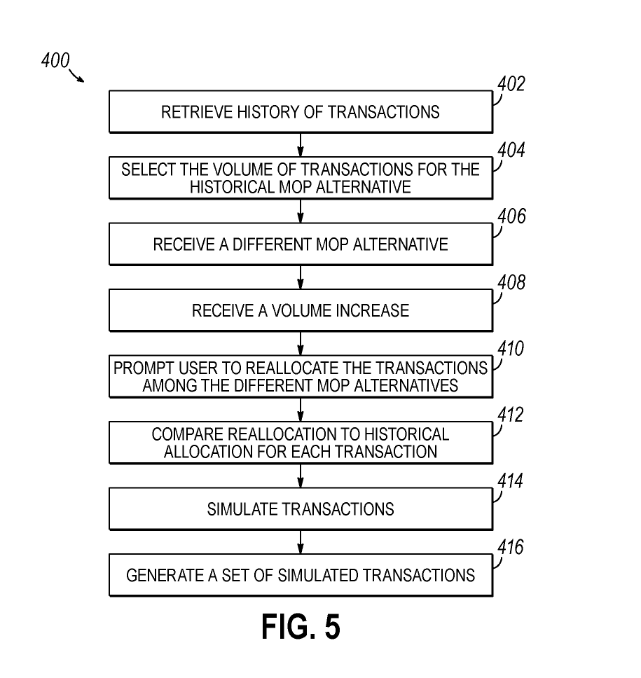

With reference to FIG. 5, a flow chart 400 detailing the generation or determination of a set of simulated transactions (block 204 of FIG. 3) for the method of payment is now described. For simplicity of the description, the previous representative use case is also taken as an example to detail the process.

A history or volume of past transactions is retrieved by the computer system 100 and used as a set of transactions for the simulations (block 402). The volume of historical transactions to be taken into consideration may be based on those transactions executed over a given time period (e.g., several months) and stored in a transactions database. The transactions database may be located at the computer system 100. In block 404, the volume of historical transactions corresponding to the ‘historical’ alternative (MOP_Alt1) 312 for category 302 (FIG. 4) may be identified from among the past volume of historical transactions. The individual volumes may be specified as percentages of a total volume, and distributed among the different MOPs. For the purpose of illustration, the volume of the historical transactions for MOP_Alt1 may be split into 60% for Visa and 40% for MasterCard with a total volume of past transactions equal to their sum, i.e., 100%. These representative volumes of historical transactions may be displayed on a user interface in, for example, a tabular form (Table 1).

TABLE 1

| Historical MOPs | Volume of historical MOP transactions |
|---|---|
| Visa | 60% |
| MasterCard | 40% |
| Total | 100% |

In block 406, the computer system 100 may receive one of the other alternatives 312 belonging to the category 302 for MOP as the subject alternative to be simulated. For example, the alternative (MOP_Alt2) 312 may be selected and, thereby, another payment item 310 (i.e., Amex) is introduced in comparison with the payment items 310 of alternative (MOP_Alt1) 312. In block 408, the computer system 100 may receive an increase for the volume of transactions obtained by the alternative. The user may be prompted by the computer system 100 to select one of the other alternatives 312 as the subject alternative and prompted by the computer system 100 to define the increase for the volume of transactions. In the illustrative example, the user may select a +5% increase in the total volume of transactions, which provides a total volume of 105% (see Table 2).

TABLE 2

| MOPs | Volume of historical MOP | Volume with the added MOP |
|---|---|---|
| Visa | 60% | 60% |
| MasterCard | 40% | 40% |
| Amex | 0% | 5% |
| Total | 100% | 105% |
| Volume | | |

In block 410, the computer system 100 may receive a reallocation of the volume of transactions among the different payment items. The user may be prompted by the computer system 100 to reallocate the volume of transactions. In the exemplary embodiment, as shown in Table 3, the user selects to have +10% of transactions for the new MOP payment item ‘Amex’, and to reduce the volume for the historical MOP items from 60% to 57% for Visa and from 40% to 38% for MasterCard (see Table 3).

TABLE 3

| | Volume of | |
|---|---|---|
| MOPs | historical MOP | Reallocated Volume with the added MOP |
| Visa | 60% | 57% |
| MasterCard | 40% | 38% |
| Amex | 0% | 10% |
| Total | 100% | 105% |

In block 412, the computer system 100 may compare, for each transaction of the past volume of transactions, the historical allocation of transactions (Volume 1) to the reallocation of transactions (Volume 2) received by the computer system 100 from the user for the alternative.

In block 414, the computer system 100 executes a simulation routine on all transactions of the set of historical transactions. The simulation routine executed by the computer system 100 sets a probability for each of the payment items for MOP depending on the reallocation provided by the user and received by the computer system 100. For each payment item having a lower volume in the reallocation (Volume 2) than the volume in the original allocation (Volume 1), the process retains the historical transaction and puts it in the set of simulated transactions with a probability equal to Volume2/Volume1. For each payment item having a higher volume in the reallocation (Volume 1) than the volume in the original allocation (Volume 2), the historical transaction is retained and put into the set of simulated transactions, and then put again in the set of simulated transactions with a probability equal to (Volume2/Volume1−1).

In the illustrative example, each historical transaction is added to the set of simulated transactions with a modified probability. Specifically, the historical transactions with Visa as a MOP are added to the set of simulated transactions with a probability of 57%/60%, and the historical transactions with MasterCard as a MOP are added to the set of simulated transactions with a probability of 38%/40%.

In the illustrative example, each historical transaction is added to the set of simulated transaction with a modified probability, and is associated with a new MOP payment item. The modified probability is equal to p=Volume 2 for new MOPs/Volume 1 for all historical MOPs. If there are multiple new MOP payment items, then each of these added transactions has a new method of payment MOP(i) assigned to it with an individual probability equal to pᵢ/p, where pi are the individual percentages of the different new MOP payment items.

In the illustrative example, the process flow cycles through all transactions in the historical set again and copies the transactions into the new simulated set of transactions with a probability of 10%, and changes the previously unidentified MOP (now with a probability of 10%/10%) in the simulation to read Amex.

Finally, in block 416, a set of simulated transactions is generated by the computer system 100 for the selected alternative 312.

Another illustrative example is given below for the process flow of generating another set of simulated transactions, specifically for the alternative (MOP_Alt3) 312 that includes Visa, MasterCard, Amex, PayPal and that has a rule defined as ‘PayPal is used for the US only’, using the computer system 100.

As previously described, after the computer system 100 retrieves the historical transactions, the user defines by how much the new alternative will increase the total sales volume of transactions. In the illustrative example, because a MOP rule is defined with respect to territories or countries, the user defines 5% for countries other than the United States and 10% for the United States. The user is then prompted to modify the historical transaction split to reflect a new transaction split with the new MOP (i.e., PayPal) for the different countries or regions. An exemplary splitting for countries other than the United States is given in Table 4, and an exemplary splitting for the United States is given in Table 5.

TABLE 4

| MOPs | Volume of historical MOP | Volume with the added MOP |
|---|---|---|
| Visa | 65% | 65% |
| MasterCard | 35% | 35% |
| Amex | 0% | 5% |
| Total | 100% | 105% |

TABLE 5

| MOPs | Volume of historical MOP | Volume with the added MOP |
|---|---|---|
| Visa | 58% | 58% |
| MasterCard | 42% | 42% |
| Amex | 0% | 5% |
| PayPal | 0% | 5% |
| Total | 100% | 110% |

The user is then prompted to reallocate the volume of transactions among the payment items for MOP, as shown in Table 6 for countries other than the United States and in Table 7 for the United States.

TABLE 6

| MOPs | Volume of historical MOP | Volume with the added MOP |
|---|---|---|
| Visa | 65% | 63% |
| MasterCard | 35% | 34% |
| Amex | 0% | 8% |
| Total | 100% | 105% |

TABLE 7

| MOPs | Volume of historical MOP | Volume with the added MOP |
|---|---|---|
| Visa | 58% | 52% |
| MasterCard | 42% | 38% |
| Amex | 0% | 12% |
| PayPal | 0% | 8% |
| Total | 100% | 110% |

Simulations are run by the computer system 100 for all transactions in the set of past or historical transactions with the inputs defined by the user and received at the computer system 100. The simulations use transaction probabilities depending upon the user's inputs for the existing MOP items in the historical alternative, and use other probabilities for the new MOP items added by the different alternative.

In the example, all transactions of the past set of transactions are simulated a probability of 63%/65% if the transaction is a Visa transaction and not transacted in the United States, a probability of 34%/35% if the transaction is a MasterCard transaction and not transacted in the United States, a probability of 52%/58% if the transaction is a Visa transaction and transacted in the United States, and a probability of 38%/42% if the transaction is a MasterCard transaction and transacted in the United States. The historical transactions are also added to the new simulated set of transactions with a probability of 8% for transactions outside of the United States (and assigned to Amex with the individual probability for Amex equal to 8%/8%), and with a probability of 20% (the sum of 12% for Amex and 8% for Paypal) for transactions in the United States (and assigned to Amex with the individual probability for Amex equal to 12%/20% and assigned to PayPal with the individual probability for PayPal equal to 8%/20%).

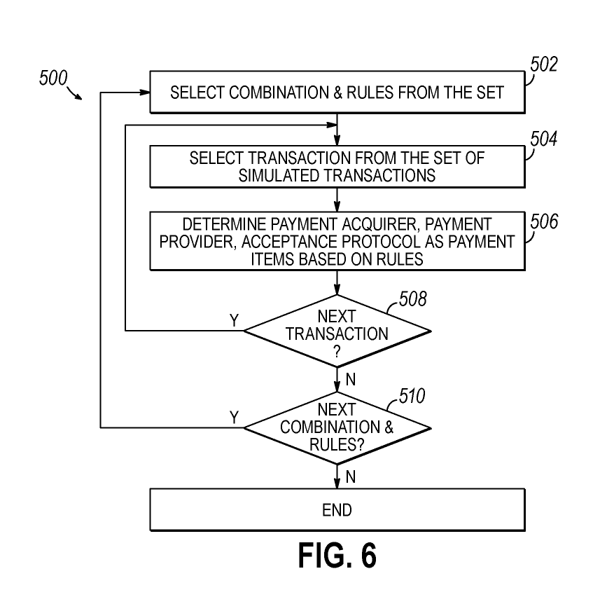

With reference to FIG. 6, a flow chart 500 is described for determining payment items from each payment category for each payment transaction in the set of simulated transactions. The process is performed or operated on a transaction-by-transaction basis within the set of simulated transactions for the different combinations in the set of combinations 320 comprising the payment alternatives 312, 314, 316, 318. In block 502, a combination of payment alternatives and associated rules is selected by the computer system 100. In block 504, a transaction is selected by the computer system 100 from the set of simulated transactions (block 416). In block 506, the transaction for the first selected combination is simulated at the by the computer system 100 and a payment processor, a payment acquirer, and an acceptance strategy are determined based on the rules. In block 508, control is transferred to block 504 to for the computer system 100 to select another simulated transaction (branch Yes) or is transferred going to block 510 for the computer system 100 to determine if all combinations/rules have been simulated. When all combinations/rules have been iteratively simulated by the computer system 100 for the all set of simulated transactions, the process flow ends.

For Combinations 1 and 2 of the illustrative example, all historical transactions are linked to Bank_Alt1 as the payment acquirer and PSP_Alt1 as the payment processor. Then, depending on the rules in FraudMgt_Alt1 that is alternative 318 for transaction acceptance protocol in Combinations 1 and 2, it is determined for each transaction whether the transaction should be accepted, rejected or denied. For Combination 3 of the illustrative example, all historical transactions are linked to Bank_Alt1 as the payment acquirer and PSP_Alt2 as the payment processor. Transaction FraudMgt_Alt2 applies as the alternative 318 for transaction acceptance protocol, which means in the illustrative example the acceptance decision will be 3D Secure.

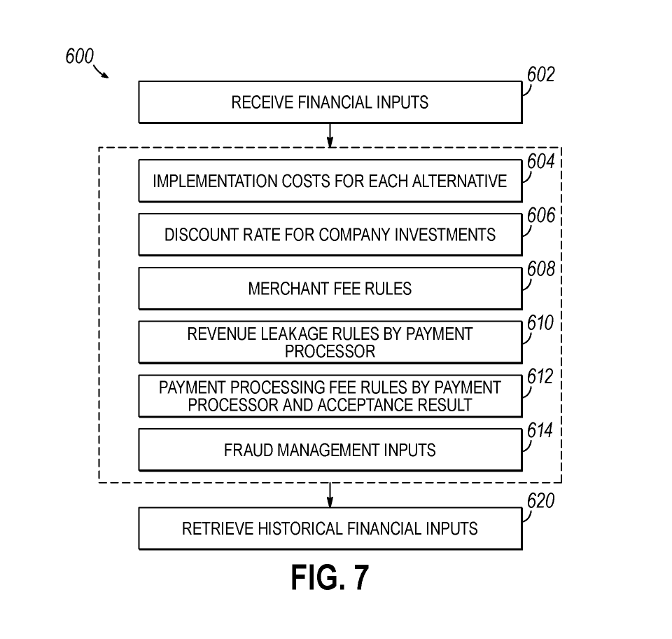

With reference to FIG. 7, a flow chart is described for acquiring financial parameters or inputs from the user. In block 602, the computer system 100 receives a plurality of financial parameters that is further used to advance the process to determine the financial strategy. The user may be prompted for the financial parameters that are received at the computer system 100.

For example, the following financial parameters may be defined by the user and received at the computer system 100. One financial parameter received by the computer system 100 may be the implementation costs 604 for each payment combination. In the illustrative example, these costs could be defined by the user. Specifically, for the Combination 1, the implementation costs 604 are 0 [symbol] because this is the historical combination; for the Combination 2, the implementation costs 604 are 0 [symbol] because the payment provider is the same as in Combination 1; and for Combination 3, the implementation costs 604 are 100,000 [symbol] because the payment provider changes along with the need to implement communication to the payment acquirer. The values herein defined are representative and should not be interpreted as fixed values, as well as for the currency which can be defined in different currencies such as, for example, dollars. Another financial parameter 606 may be the discount rate for company investments: e.g., 15%.

Another financial parameter 608 received by the computer system 100 may be the merchant fee rules based on bank and transaction information. For the illustrative example, the fee rules could be defined as a fee of 0.6% for a Visa or MasterCard transaction, a fee of 0.3% for a Visa or MasterCard transaction with 3D Secure validation, a fee of 2% for an Amex transaction, and a fee of 3% for a PayPal transaction.

Yet another financial parameter 610 received by the computer system 100 may be the revenue leakage rules of the payment processor. For the illustrative example, the revenue leakage rules may be defined as 0.3% for payment provider PSP_Alt1 and 0% for payment provider PSP_Alt2. Another financial parameter 612 received by the computer system 100 may be the payment processing fee rules. For the illustrative example, the payment processing fee rules may be 6 cents per transaction for payment provider PSP_Alt1 and 5 cents per transaction for payment provider PSP_Alt2. Another financial parameter 614 may be the fraud management inputs, which result in a fraud probability of a rejected transaction, e.g., 20% payment provider PSP_Alt1 and 5% payment provider PSP_Alt2, a chargeback penalty, e.g., 20 [symbol] per chargeback, a cost of processing one chargeback, e.g., 5 [symbol] , a cost of performing one manual review, e.g., 3 [symbol] , a gross margin, e.g., 20% for all products, an abandonment rate, e.g., 50%, a false positives of manual review process, e.g., 20% and a false negatives of manual review process, e.g., 20%, a false positives of 3D Secure process, e.g., 2% and a false negatives of manual review process, e.g. 20% for all countries.

After inputting all the requested financial parameters, a plurality of historical financial inputs are retrieved by the computer system 100 (block 620). The historical financial inputs may be retrieved either with a total cost of merchant fees, revenue leakage and payment processing fees, and total cost of fraud, or with merchant fees, revenue leakage, payment processing fees, and total cost of fraud inputs.

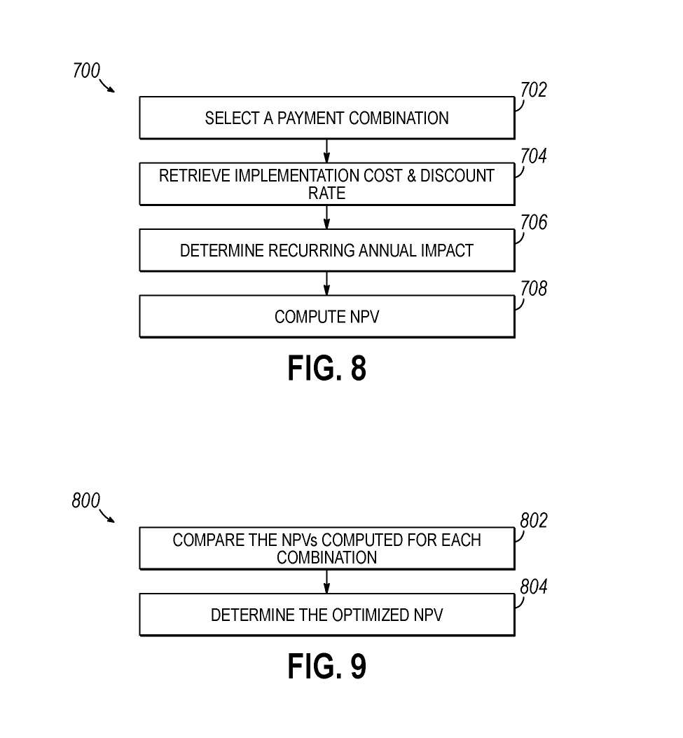

With reference to FIG. 8, a flow chart is described for the determination of the net profit value (NPV) for each combination in the set of combinations 320 comprising the payment alternatives 312, 314, 316, 318 on the basis of the previously-received financial inputs. In block 702, one of the payment combinations is selected by the computer system 100. In block 704, the financial parameter 604 of the implementation cost ‘imp_cost’ and the financial parameter 606 of the discount rate ‘d’ are retrieved by the computer system 100. In block 706, a recurring annual impact is determined by the computer system 100. A recurring annual incremental impact ‘an_imp’ is determined by summing the annual impact for each new alternative and subtracting the historical alternative annual impact. The determination of the recurring annual impact may include determining the cost differences for the various previously-defined financial parameters: e.g., merchant fee, payment processing fee, revenue leakage, and total fraud cost.

In block 708, a NPV is determined by the computer system 100 for the currently-selected payment combination. If additional payments combinations of the payment alternatives 312, 314, 316, 318 are to be analyzed, then the next payment combination is selected and control returns to block 704.

By way of example, for Combination 2 that includes MOP_Alt2 as the alternative 312 for method of payment, the impact on the annual gross margin is computed by summing the amount of the whole set of simulated transactions, comparing it to the amount of the historical transactions, and determining the gross margin. As a numerical example, an amount of the initial sales with the historical alternative of the airline merchant be equal to 200 MEUR (million Euros), with a 20/80 split between the United States and the rest of the world. For Combination2, the worldwide gain in annual volume is calculated to be 2.5%, which leads to an incremental increase of 10 MEUR in sales (i.e., total sales of 210 MEUR) and, therefore, to an incremental increase in gross margin of 2 MEUR.

The impact may also be determined for the merchant fee for each transaction. The cumulated historical and the cumulated new merchant fee amounts are calculated over all transactions in the historical and the new sets of transactions, and then subtracted. As a numerical example, a historical merchant fee of 0.6% (fee for Visa or MasterCard transaction without 3D Secure) may be applied over the 200 MEUR sales. This results in a 1.2 MEUR in total historical merchant fees. A new merchant fee of 0.6% may be applied for Visa and MasterCard transactions with a ratio of 95%/105% of new amounts and a new merchant fee of 2% for Amex transactions with a ratio of 5%/105% of new amounts. By assumption, the Amex transactions have the same average amount than the Visa and MasterCard transactions. The total new merchant fee is then determined by the computer system 100 as:

210 MEUR*0.6%*95%/105%+210M*2%*5%/105%=1.34 MEUR

Therefore, upon comparison of the new merchant fee for Combination 2 with the total historical merchant fee for Combination 1, the annual difference in merchant fees is equal to −0.14 MEUR.

The impact may also be determined by the computer system 100 for the payment processing fee. Similarly, the cumulated historical and cumulated new payment processing fees may be calculated over all transactions in the historical and the new sets of transactions, and then subtracted. As a numerical example, an amount of average transaction may be set equal to 200 EUR, and the historical set of transactions containing 1M transactions and the new one 1.05 MEUR. The historical cumulated payment processing fee is therefore equal to 1M*0.05=0.05 MEUR and the cumulated new payment processing fee is equal to:

1.05M*0.05=0.0525 MEUR.

Therefore, when the new payment processing fee for Combination 2 is compared with the historical payment processing fee for Combination 1, the annual difference in payment processing fees is equal to 0.0025 MEUR.

The impact may also be determined by the computer system 100 for the revenue leakage. Similarly, the cumulated historical and cumulated new revenue leakage may be calculated over all transactions in the historical and the new sets of transactions, and then subtracted. As a numerical example, the average revenue may be set equal to 0.3%. The historical revenue leakage for Combination 1 is equal to 200 MEUR*0.3%=0.6 MEUR and the new revenue leakage for Combination 2 is equal to 210 MEUR*0.3%=0.63 MEUR. Therefore, upon comparison of the historical and new revenue leakages, the annual difference in revenue leakage is equal to −0.03 MEUR.

Finally, the impact may also be determined by the computer system 100 for the total cost of fraud. Similarly, the cumulated historical and cumulated new total cost may be calculated over all transactions in the historical and the new sets of transactions, and then subtracted. As a numerical example, a total cost of fraud may be set to about 2% as the same fraud management strategy is used for Combinations 1 and 2. The historical total cost of fraud is equal to 200 MEUR*2%=4 MEUR for Combination 1 and the new total cost of fraud for Combination 2 is equal to 210 MEUR*2%=4.2 MEUR. Therefore, upon comparison of the historical and new total costs of fraud, the annual difference in the total cost of fraud is equal to −0.2 MEUR.

Then, the annual incremental impact ‘an_imp’ is determined as a sum of the individual impact components:

2 MEUR−0.14 MEUR−0.0025 MEUR−0.03 MEUR−0.2 MEUR=1.63 MEUR

The NPV is then computed, for example, over a given time period. For example, the NPV may be computed over five years as follow:

NPV(5years)=an_imp/d*(1−1/(1+d)⁵)−imp_cost

Because there the implementation costs are nil for this combination, the NPV is equal to:

1.63 MEUR/15%*(1−1/115%̂5)=5.46 MEUR

Similarly, the previous computations of impacts may be performed for an example based on Combination 2. For annual gross margin, a gain in annual volume of 5% outside the US is determined, which produces an incremental increase in sales of 200 MEUR*80%*5%=8 MEUR. For the United States, the gain in annual volume is determined to be 10%, which produces an incremental increase in sales of 200 MEUR*20%*10%=4 MEUR. Consequently, when the components are summed to create worldwide totals, the worldwide increase in sales for Combination 2 is determined to be 12 MEUR and the incremental increase in gross margin for Combination 2 is determined to be 2.4 MEUR.

With respect to the merchant fee for Combination 2, the new merchant fee may 0.6% for Visa and MasterCard with a ratio of 90%/110% of US amounts and 97%/105% of non-US amounts, the new merchant fee may be 2% for Amex transactions with ratios of 12%/110% of US amounts and 10%/105% of non-US amounts, and the new merchant fee may be 3% for PayPal transactions with ratio of 8%/110% of US amounts. The total new merchant fee is computed as:

210 MEUR*(0.3%*(20%*90%/110%+80%*97%/105%)+2%*(20%*12%/110%+80%*10%/105%)+3%*(20*8%/100%))=1.08 MEUR.

Therefore, when comparing the merchant fee for Combination 1 with the merchant fee for Combination 2, the annual difference in merchant fees is equal to 1.2 MEUR−1.08 MEUR=0.12 MEUR.

With respect to the payment processing fee for Combination 2, the cumulative payment processing fee is determined to be 212M/200*0.06=0.0636 MEUR. Therefore, when comparing the payment processing fee for Combination 1 with the payment processing fee for Combination 2, the annual difference in payment processing fees is equal to the difference:

0.05 MEUR−0.0636 MEUR=−0.0136 MEUR.

With respect to revenue leakage, the revenue leakage with the new payment processor is 0%. Therefore, the annual difference in revenue leakage is equal to 0.6 MEUR. With respect to the total cost of fraud, the total cost of fraud may be assumed to be about 3% for a 3D Secure strategy because a different fraud management strategy is used in Combination 2. The new total cost of fraud would be equal to 212 MEUR*3%=6.36 MEUR. Therefore, when comparing the total cost of fraud for Combination 1 with the total cost of fraud for Combination 2, the annual difference in total cost of fraud is equal to −2.36 MEUR.

Finally, the annual incremental impact ‘an_impact’ is equal to the sum of the individual impacts:

2.4 MEUR+0.12 MEUR−0.0136 MEUR+0.6 MEUR−2.36 MEUR=0.75 MEUR

Because the implementation costs are 100K [symbol] for deploying the solution of this alternative, the 5-year NPV is computed as being equal to:

0.75 MEUR/15%*(1−1/115%̂5)=2.6 MEUR

FIG. 9 is a flow chart of a process for determining an optimized NPV after the NPVs have been computed by the computer system 100 in previous block 708 of FIG. 8. In block 802, the different values for NPV computed for each payment combination are compared by the computer system 100. In block 804, the payment combination corresponding to the optimized NPV is identified by the computer system 100 as the optimized payment combination. More precisely, if all payment combinations have a negative NPV, then the historical payment combination is determined by the computer system 100 to be the optimized one. If some payment combinations have a positive NPV, the payment combination from among these that has the highest NPV is determined to be the optimized payment combination for use by a payment platform for an airline merchant. The computing system may cause the highest net profit value and one or more of associated data comprising one or more financial parameters, impact on payment category, or total financial impact to be displayed to the user.

For the previous example, the process would generate as the result that the payment combination based on Combination 2 is the optimized payment combination with a NPV of 5.46 MEUR compared to the NPV of 2.6 MEUR of the Combination 3, even if the sales increase is not as much as for Combination 3. Combination 3 is selected because it creates more merchant fees and a better total cost of fraud.

The program code embodied in any of the applications/modules described herein is capable of being individually or collectively distributed as a program product in a variety of different forms. In particular, the program code may be distributed using a computer readable media, which may include computer readable storage media and communication media. Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. Communication media may embody computer readable instructions, data structures or other program modules. By way of example, and not limitation, communication media may include wired media such as a wired network or direct-wired connection, and wireless media such as acoustic, RF, infrared and other wireless media. Combinations of any of the above may also be included within the scope of computer readable media.

These computer program instructions may also be stored in a computer readable medium that can direct a computer, other types of programmable data processing apparatus, or other devices to function in a particular manner, such that the instructions stored in the computer readable medium produce an article of manufacture including instructions that implement the function/act specified in the block or blocks of the flowchart and/or block diagram.

The computer program instructions may also be loaded onto a computer, other programmable data processing apparatus, or another device to cause a series of computations to be performed on the computer, the other processing apparatus, or the other device to produce a computer implemented process such that the executed instructions provide one or more processes for implementing the functions/acts specified in the flowchart and/or block diagram block or blocks.

The terminology used herein is for the purpose of describing particular embodiments only and is not intended to be limiting of the embodiments of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Furthermore, to the extent that the terms “includes”, “having”, “has”, “with”, “comprised of”, or variants thereof are used in either the detailed description or the claims, such terms are intended to be inclusive in a manner similar to the term “comprising.”

While all of the present invention has been illustrated by a description of various embodiments and while these embodiments have been described in considerable detail, it is not the intention of the Applicant to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of the Applicant's general inventive concept.

1. A method for determining a payment strategy for a payment platform, the method comprising:
receiving, at a processor, a plurality of financial parameters, a plurality of categories, and one or more payment items for each category;
determining one or more alternatives for each category, each alternative including at least one of the one or more payment items;
simulating, at the processor, a plurality of transactions for a plurality of combinations of the alternatives;
determining, at the processor, a plurality of financial impacts for each simulated transaction based on the financial parameters; and
determining, at the processor, one of the combinations of the alternatives based on the financial impacts as the payment strategy for the payment platform.

2. The method of claim 1 further comprising:
receiving, at the processor, a payment rule that applies to the payment items of one of the payment categories.

3. The method of claim 2 wherein the payment rule comprises a plurality of payment restrictions according to geographic territory for the transactions.

4. The method of claim 1 wherein determining the financial impacts comprises:
determining a net profit value for each simulated payment transaction.

5. The method of claim 4 further comprising:
determining a total financial impact by comparing the net profit values.

6. The method of claim 5 wherein determining the one of the combinations of the alternatives further comprises:
selecting the combination of the alternatives with the net profit value that is highest.

7. The method of claim 1 wherein the categories are selected from the group consisting of a method of payment, a payment acquirer, a payment processor, a transaction acceptance protocol, or a combination thereof.

8. The method of claim 1 wherein a set of historical transactions is used to simulate the transactions for the combinations of the alternatives, and the set of historical transactions includes past transactions transacted for one of the combinations.

9. A system for determining a payment strategy for a payment platform, the system comprising:
at least one processor; and
a memory coupled with the at least one processor, the memory including program code configured to be executed by the at least one processor to cause the at least one processor to:
receive a plurality of financial parameters, a plurality of categories, and one or more payment items for each category;
determine one or more alternatives for each category, each alternative including at least one of the one or more payment items;
simulate a plurality of transactions for a plurality of combinations of the alternatives;
determine a plurality of financial impacts for each simulated transaction based on the financial parameters; and
determine one of the combinations of the alternatives based on the financial impacts as the payment strategy for the payment platform.

10. The system of claim 9 wherein the program code is configured to be executed by the at least one processor to cause the system to:
receive a payment rule that applies to the payment items of one of the payment categories.

11. The system of claim 10 wherein the payment rule comprises a plurality of payment restrictions according to geographic territory for the transactions.

12. The system of claim 9 wherein the program code configured to be executed by the at least one processor to cause the system to determine the financial impacts comprises:
program code configured to be executed by the at least one processor to cause the system to determine a net profit value for each simulated payment transaction.

13. The system of claim 12 wherein the program code is further configured to be executed by the at least one processor to cause the system to:
determine a total financial impact by comparing the net profit values.

14. The system of claim 13 wherein the program code configured to be executed by the at least one processor to cause the system to determine the financial impacts to determine one of the combinations of the alternatives further comprises:
program code configured to be executed by the at least one processor to cause the system to select the combination of the alternatives with the net profit value that is highest.

15. The system of claim 9 wherein the categories are selected from the group consisting of a method of payment, a payment acquirer, a payment processor, a transaction acceptance protocol, or a combination thereof.

16. The system of claim 9 wherein a set of historical transactions is used to simulate the transactions for the combinations of the alternatives, and the set of historical transactions includes past transactions transacted for one of the combinations.

17. A computer program product comprising:
a non-transistory computer readable storage medium; and
program code stored on the computer readable storage medium and configured, upon execution, to cause at least one processor to:
receive a plurality of financial parameters, a plurality of categories, and one or more payment items for each category;
determine one or more alternatives for each category, each alternative including at least one of the one or more payment items;
simulate a plurality of transactions for a plurality of combinations of the alternatives;
determine a plurality of financial impacts for each simulated transaction based on the financial parameters; and
determine one of the combinations of the alternatives based on the financial impacts as a payment strategy for a payment platform.
